(19) United States
(12) Patent Application Publication
(10) Pub. No.: US 2015/0270747 A1
(43) Pub. Date: Sep. 24, 2015

(54) SYSTEM AND METHOD FOR CONTROLLING MULTIPHASE ELECTRIC MOTORS

(71) Applicants: Chevron U.S.A. Inc., San Ramon, CA (US); THE TEXAS A&M UNIVERSITY SYSTEM, College Station, TX (US)

(72) Inventors: Hamid Toliyat, College Station, TX (US); Masoud Hajiaghajani, Houston, TX (US); Vivek Meenakshi Sundaram, College Station, TX (US); Yateendra Deshpande, College Station, TX (US); Mina Rahimian, College Station, TX (US); Nwamaka Nzeocha, Houston, TX (US)

(73) Assignees: THE TEXAS A&M UNIVERSITY SYSTEM, College Station, TX (US); Chevron U.S.A. Inc., San Ramon, CA (US)

(21) Appl. No.: 14/223,200

(22) Filed: Mar. 24, 2014

(51) Int. Cl. H02K 1/16; H02K 11/00; H02K 1/27; H02K 3/28; H02K 1/02; H02K 1/26

(52) U.S. Cl. CPC H02K 1/16; H02K 1/02; H02K 1/26; H02K 1/2706; H02K 3/28; H02K 11/0073

(57) ABSTRACT

A multiphase electric motor for a down-hole electrical submersible pump having a rotor having a first set of rotor voids filled or partially filled with permanent magnetic material. The electric motor having a stator with three or more stator slots, three or more stator teeth and three or more coils. Individual ones of the three or more coils are wound about at least one of the individual ones of the three or more stator teeth, and positioned such that adjacent coils are non-overlapping or partially overlapping to form a fractional slot per pole per phase winding. The electric motor having a power supply configured to provide power to the three or more phase windings formed by series or parallel combination of the three or more coils and a controller configured to control transmission of power through the three or more windings.

### FIELD OF THE DISCLOSURE

This disclosure relates to electrical motors and, in particular, for electrical motors used in electrical pumps for high power offshore submersible pump applications.

### BACKGROUND

Electrical motors for use in high power offshore submersible pump applications, such as oil wells, typically use three-phase asynchronous induction motors with two poles and a distributed winding. The low pole number enables high speed operation at around 3500-rpm when using 60 Hz supply. The induction motors are also typically driven by a variable frequency drive that enables operations at varying speeds depending on the required flow rates through a submersed pipe.

Due to the high temperature in the well, improper cooling and overloading can result in the breakdown of ground wall insulation leading to inter-turn, phase to phase and phase-to-ground faults in the stator winding. Additionally, due to the long length of the electric cable providing power to the electric motor, there is an increased risk of a reflected voltage wave increasing the instantaneous voltage at the motor terminals above their rated value—especially during start-up of the motor. This phenomenon can also lead to insulation breakdown and cause phase-to-phase or phase-to-ground faults. Such faults lead to the loss of one or more phases, rendering the motor inoperable and in need of replacement. In typical motors, the end windings of the different phases overlap each other allowing faults to migrate to healthy phases leading to phase-to-phase faults.

When a motor fails it may need to be replaced. Replacing an electrical motor, such as in a submersible electric pump, may be time consuming and costly.

### SUMMARY

Increasing the number of phases for the electric motor in an electrical pump allows the electrical pump to perform after one or more phases has failed. Additionally, a fractional slot per-pole per-phase (SPP) ratio, which produces windings with minimal to no overlap between the end windings of the phases may reduce likelihood of phase-to-phase faults. Such windings may be used with induction, permanent magnet synchronous motors (PMSM), synchronous reluctance motors (SynRM) and permanent magnet assisted synchronous (PMa-SynRM) reluctance motors.

When one or more phases of a high phase number motor are in fault, it is possible to continue operation of the motor using the remaining phases. For example, if the electric motor is a five-phase electric motor, the motor may still operate when one phase or even two phases are in fault. Such motors may have a minimum number of phases not in fault in order to remain operational.

When one or more phases are in fault, the phase shift between the remaining healthy phases is determined to satisfy certain constraints. Such constraints may include configuring the system so that the total instantaneous current is approximately zero, ensuring that there is no zero sequence current present which can lead to bearing failure losses and/or, configuring the harmonic torque ripple to be approximately zero. For permanent magnet type motors, an analytical field solution of the air gap flux density due to the magnets may be used to calculate the required phase shifts between the currents in the healthy phases to reduce the second harmonic torque. A more accurate compensation may be achieved by injecting third and higher harmonic currents to additionally reduce the fourth and higher harmonic torque ripple that is created during phase faults. For induction and SynRM motors, compensation may be achieved by including the effect of third and higher order harmonic magneto-motive force (MMF) produced by the stator winding during faults. By injecting third and higher harmonic currents, it may be possible to reduce the second and higher harmonic torque when operating under fault and achieve higher average torques. One aspect of the disclosure relates to providing a multiphase electric motor for a down-hole electrical submersible pump. The electric motor may have a rotor having a first set of rotor channels. Where the electric motor is an induction motor, the first set of rotor channels may comprise rotor slots. Where the electric motor is a permanent magnet motor, the first set of rotor channels may comprise voids, wherein the voids may be partially or completely filled with magnets depending on the desired properties of the motor. The multi-phase electric motor may comprise a selected amount of permanent magnet material distributed on the outer periphery of the rotor. The electric motor may comprise an amount of permanent magnet positioned at individual locations on the outer periphery of the rotor and/or in individual ones of the first set of rotor channels, wherein the amount of permanent magnet material positioned on the outer surface of the rotor, and/or in the channels, may be determined to provide a desired torque density and efficiency. The shape of the permanent magnet material disposed on the outer surface, and/or in the channels, may be configured to provide a desired torque density and efficiency of the electric motor.

The first set of rotor channels may be distributed on the outer surface of the rotor and may include a selected amount of permanent magnet material positioned in individual ones of the first set of rotor channels. The permanent magnet material may be a samarium-cobalt magnetic material.

The electric motor may have a winding positioned radially outward from the rotor. The electric motor may comprise a stator having three or more stator slots, three or more stator teeth and three or more coils. Individual ones of the three or more coils may be wound about at least one of the individual ones or more of the three or more stator teeth. In some implementations there may be more than one coil wound around the individual ones or more teeth. The individual ones of the three or more coils may comprise end windings adjacent to the ends of the stator. The coils may be positioned such that the end windings of adjacent coils at the ends of the stator are non-overlapping or partially overlapping as a result of having a slot per pole per phase of less than 1.0.

The coils may be formed using solid conductors or stranded conductors. Solid conductors may provide a higher fill factor for the coils which may provide increased thermal contact with a lining of the slots. The coils comprising one or more solid conductors may have flat edges providing thermal contact with a lining of individual ones of the first set of stator slots. The one or more solid conductors may have a shape selected to match the shape of the first set of stator slots.

Where the end windings of adjacent coils are non-overlapping, each coil returns from a neighboring slot so that only one coil passes over an individual tooth of the stator. In such configurations, the coil is said to span over one stator tooth. Where the end windings of the adjacent coils are partially overlapping, each coil returns from the slot next to the neighboring slot so that two coils pass over an individual tooth of the stator. In such configurations, the coil is said to span over two stator teeth.

The electric motor may have a first set of phases, wherein the first set of phases is comprised of three or more phases. The phase windings may be formed by series or parallel combination of one or more coils.

The electric motor may comprise a power supply configured to provide power to the three or more phases. The power supply may be configured to provide power to the three or more phase windings formed by series or parallel combinations of the three or more coils. When one or more phases of the electric motor are in fault the power supply may be configured to provide power to less than the three or more phases, for example, the power supply may be configured to provide power to the remaining healthy phases of the electric motor. The system may be configured to adapt the power supply to provide power to the remaining healthy phases automatically and/or without user involvement. The electric motor may comprise a controller configured to control transmission of power through the three or more phase windings. The controller may be configured to modify the phase angle between the power transmitted through individual ones of the three or more windings. The controller may be configured to modify the phase angle between a voltage induced in the windings and the current applied to the windings.

When a sinusoidal current is applied to the motor, the angle between the zero crossing of the current in each phase may be fixed depending on the number of phases.

Where the electric motor is an induction motor, the rotor of the electric motor may comprise one or more conductors distributed radially about the surface of the rotor in the first set of rotor channels. The conductors are electrically shorted with conducting rings on the top and bottom of the rotor. The number and shape of the rotor channels or slots may be selected to minimize the torque ripple and achieve a desired average torque for the electric motor. The one or more conductors may comprise solid conductors or stranded conductors. The solid conductors may have flat edges providing thermal contact with a lining of individual ones of the first set of rotor channels. The one or more solid conductors may have a shape selected to match the shape of the first set of rotor channels.

The electric motor may comprise any number of phases. For example, the electric motor may comprise three phases, five phases, six phases, seven phases or more phases, such as n phases. In some implementations, the multiphase electric motor contemplated has in excess of three phases allowing operation of the electric motor to continue subsequent to a failure of one or more phases. Controlling the transmission of power may comprise monitoring the transmission of power to phases of the electric motor.

Controlling the power transmitted to the phases may include detecting a shorted phase in the first set of phases. A short in the circuit of a winding or coil may be an indication that the winding has a fault. The step of detecting a shorted winding may comprise obtaining a resistance measurement. Such resistance measurement may be performed by an on-line DC voltage application to the electric motor circuit. For example, a faulty winding may include a winding having a short circuit. A short circuit in any winding of the electric motor may reduce the overall resistance of the electric motor. A relatively small DC voltage may be injected through an inverter of the electric motor. The current produced by the injected DC voltage may be measured to obtain an estimation of the DC resistance of the individual winding of the electric motor. The DC resistance of individual ones of the windings may be compared with each other and compared with previous measurements to obtain a measure of change of the DC resistance of individual ones of the windings. The measurement of the DC resistance may be discrete, wherein the on-line DC injection may be done at predetermined and/or selected intervals, and/or as desired, to obtain the DC resistance measurements. A faulty winding may be determined based on the DC resistance measurements of the winding indicating that the winding has a short circuit.

The temperature of the windings may affect the resistance of the windings and therefore, if not accounted for, may give a false measurement that a winding is in fault. Temperature typically affects the windings uniformly, and therefore, by comparing the changes in resistance of each of the individual windings, the effect of temperature can be accounted for. During manufacture of the windings, the windings may not be electrically balanced, and therefore unbalances in the phase windings created during manufacture may also be accounted for.

Responsive to the detection of a shorted winding, the transmission of power to the multiphase electric motor may be controlled, such that power may be transmitted to a different ones of the three or more coils or windings

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a graph showing the effect of pump speed on pump performance, in accordance with one or more configurations;

FIG. 2 illustrates a system for controlling a multiphase electric motor, in accordance with one or more implementations;

FIG. 3a illustrates a partially overlapping stator winding in accordance with one or more configurations;

FIG. 3b illustrates a partial schematic view of a partially overlapping stator winding in accordance with one or more configurations;

FIG. 4a illustrates a non-overlapping stator winding, in accordance with one or more implementations;

FIG. 4b illustrates a partial schematic view of a non-overlapping stator winding in accordance with one or more configurations;

FIG. 5 illustrates an electric motor, in accordance with one or more implementations;

FIG. 6 illustrates a cross-sectional view of a stator channel having solid conductors, in accordance with one or more implementations;

FIG. 7 illustrates an electric motor, in accordance with one or more implementations;

FIGS. 8A-8F illustrate permanent magnet rotor configurations, in accordance with one or more implementations;

FIG. 9a illustrates the torque speed curve and efficiency map for an induction motor, in accordance with one or more implementations;

FIG. 9b illustrates the torque speed curve and efficiency map for a permanent magnet motor, in accordance with one or more implementations; and,

FIG. 9c illustrates the torque speed curve and efficiency map for a permanent magnet assisted synchronous motor, in accordance with one or more implementations.

### DETAILED DESCRIPTION

Electrical motors used for high power offshore submersible pump applications are generally long cylindrical motors rated for 800-1300 HP and operating at high voltages of up to 4 kV. The outer diameter of the stator is typically restricted to the range of 4.5″ to 5.6″. These motors are submersed in the oil wells and are designed to withstand extreme temperature and pressure conditions. Conventional systems use three phase asynchronous induction motors with two poles, and hence use a distributed winding.

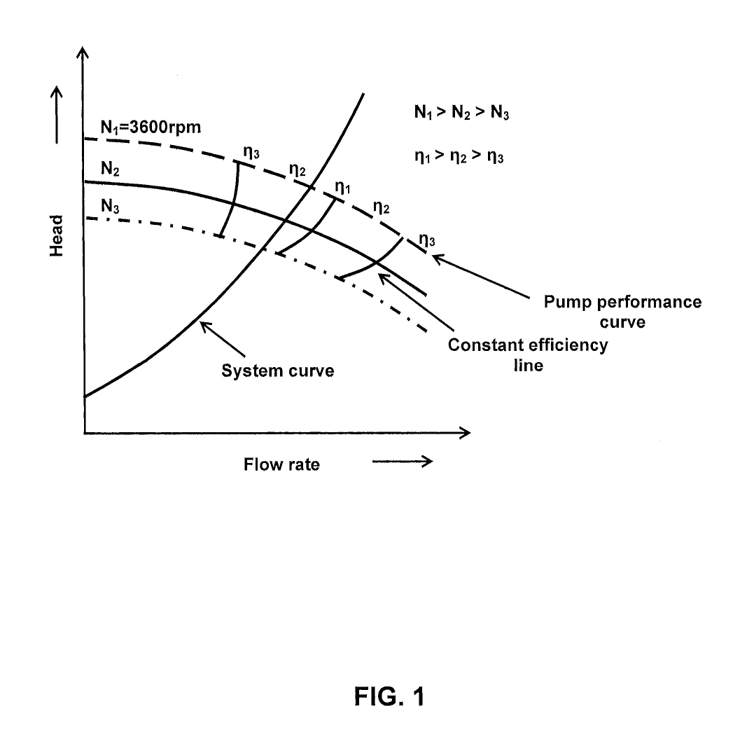

In general, depending on the well inflow conditions and total dynamic head, the system curve of the well can be estimated. The pump specifications are selected to achieve the required flow rate at the pump's peak efficiency point. This is the pump's operating point. The operating point of the pump is the intersection of the system curve and its performance curve as shown in FIG. 1. The actual operating point of the pump is difficult to predict a-priori as variations may occur due to unpredictable nature of the specific gravity and viscosity of the crude oil in the well and due to variations in certain factors, such as temperature and pipe resistance. Ideally, the pump is to be operated in the vicinity of its peak efficiency operating point, but because of the variations in certain factors, the peak efficiency operating point varies. The operating point of the ESP motor is defined by its torque and speed. When the motor's peak efficiency operating condition does not match the operating point of the pump, there will be increased power losses in the motor. The motor's life depends on its average operating temperature and reduces approximately to half for every 10° C. rise in winding temperature. When the motor fails, the well pumping system has to shut down until the motor is replaced.

Increasing the number of phases for the electric motor in an electrical pump allows the electrical pump to perform after one or more phases has failed. Additionally, avoiding overlap of the phases at the end connections, such as with a fractional slot per pole per phase (SPP) ratio, which produces windings with minimal to no overlap between the phases, may reduce phase faults from propagating to the other phases. Such windings may be used with induction, permanent magnet synchronous motors (PMSM), synchronous reluctance motors (SynRM) and permanent magnet assisted synchronous (PMa-SynRM) reluctance motors.

When one or two phases of a high phase number motor are in fault, it is possible to continue operation of the motor using the remaining phases. For example, if the electric motor is a five-phase electric motor, the motor may still operate when one phase, or even two phases, are in fault. Such motors may have a minimum number of phases not in fault in order to remain operational.

When one or more phases are in fault, the phase shift between the remaining healthy phases is determined to satisfy certain constraints. Such constraints may include: configuring the system so that the total instantaneous current is approximately zero, ensuring that there is no zero sequence current present which can lead to bearing failure losses; and/or, configuring the harmonic torque ripple to be approximately zero. For permanent magnet type motors, an analytical field solution of the air gap flux density due to the magnets may be used to calculate the required phase shifts between the currents in the healthy phases to reduce the second harmonic torque. A more accurate compensation may be achieved by injecting third and higher harmonic currents to additionally reduce the fourth and higher harmonic torque ripple that is created during phase faults. For induction and SynRM motors compensation may be achieved by including the effect of third and higher order harmonic magneto-motive force (MMF) produced by the stator winding during faults. By injecting third and higher harmonic currents, it may be possible to reduce the second and higher harmonic torque when operating under fault and achieve higher average torques.

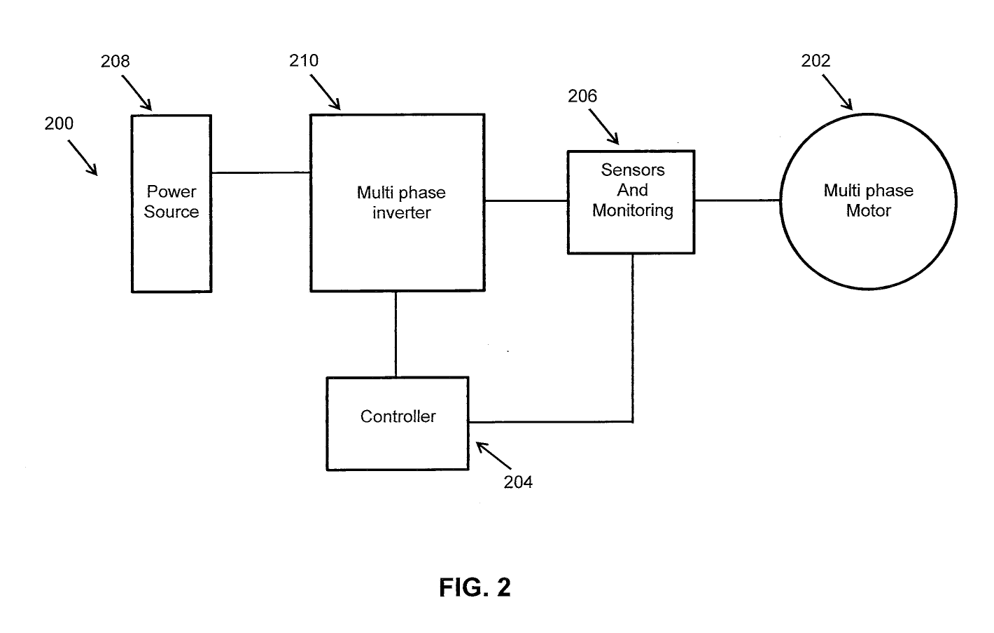

FIG. 2 illustrates a system 200 for controlling a multiphase motor 202. The multiphase motor may comprise n phases. In some implementations, the multiphase motor may comprise five phases. The system 200 may comprise a controller 204 configured to control transmission of power, delivered by inverter 210, to a first set of phases of a multiphase electric motor 202 in accordance with a first operating configuration. The first set of phases may comprise select individual ones of the n phases of the multiphase electric motor 202. In some implementations, the first set of phases may comprise all of the n phases of the multiphase electric motor 202.

The first operating configuration may be any operating configuration. The first operating configuration may include a standard vector control scheme with space vector pulse width modulation (SVPWM). Space vector modulation (SVM) is an algorithm for the control of pulse width modulation (PWM).

The system 200 may also comprise a sensor/monitoring device 206. The monitoring device 206 may be configured to monitor any number of parameters of the electric motor 202. The monitoring device 206 may be configured to detect a shorted phase in the first set of phases of the electric motor 202, while the first set of phases are being operated in accordance with the first operating configuration. The monitoring device 206 may comprise a single monitoring device configured to monitor the state of all phases in the electric motor 202. In other implementations, the monitoring device 206 may comprise multiple individual monitoring devices individually configured to monitor the state of individual ones of the phases in the electric motor 202. Individual monitoring devices may be electronically connected such that the system 200 may monitor the state of individual ones of the phases of the electric motor 202.

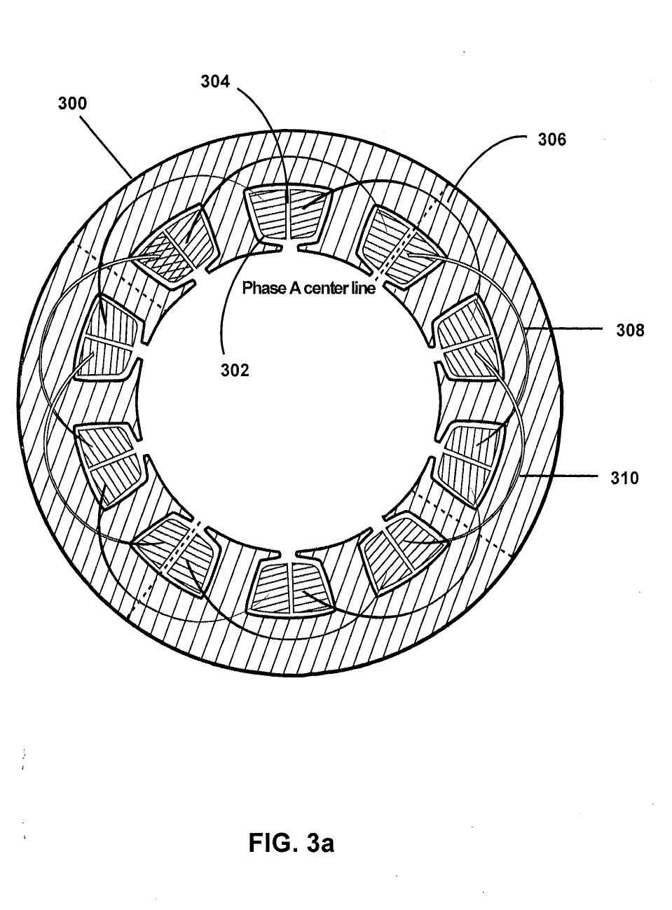

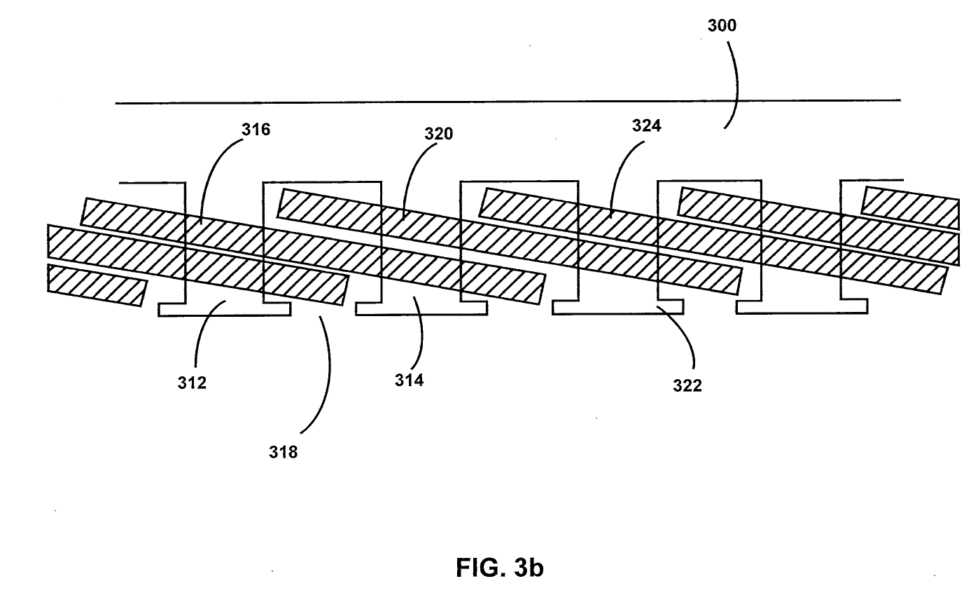

With reference to FIG. 3, shown is a schematic illustration of a stator 300 with a partially overlapping winding configuration. The stator 300 includes stator slots 302. Within the stator slots 302 are stator windings 304. The windings 304 may be configured so that the windings 304 partially overlap with other phase windings at the end connection. As a result, phases 306, 308, and 310 may partially overlap.

FIG. 3b illustrates a partial schematic view of a stator 300 with a partially overlapping winding configuration. Stator 300 may comprise stator teeth 312, 314 with stator slots 318 there between. Coils may be wound about at least two stator teeth, such that coil 316 may be would about stator tooth 312 and stator tooth 314. Similarly, coil 320 adjacent coil 316 may be wound about stator tooth 314 and stator tooth 322. In such configurations, coil 316 and coil 320 may be both wound about stator tooth 314. Therefore, coil 316 and coil 320 partially overlap. The pattern may be repeated throughout the stator, such that coil 320 may partially overlap coil 316 and coil 324.

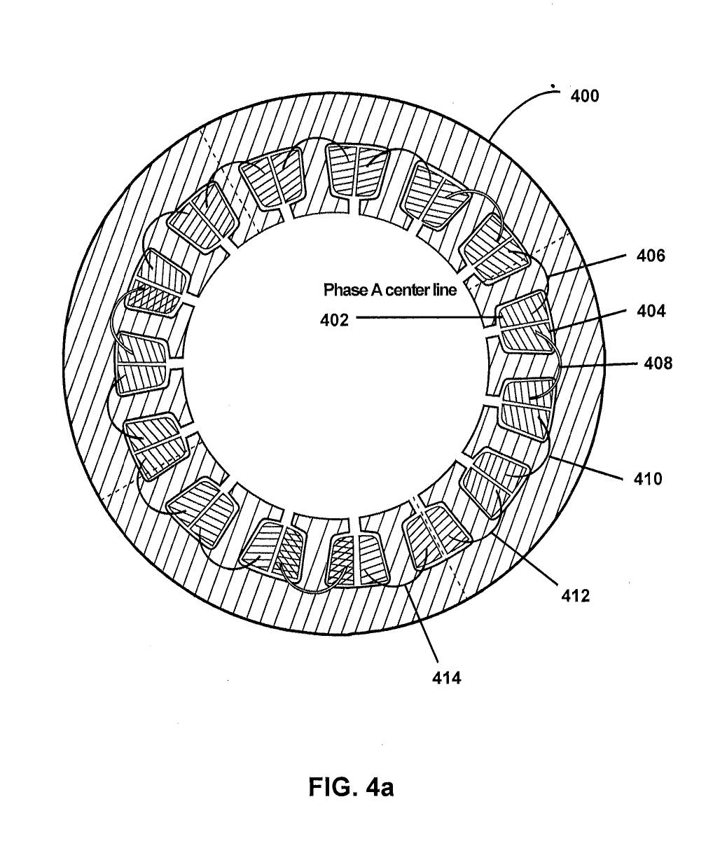

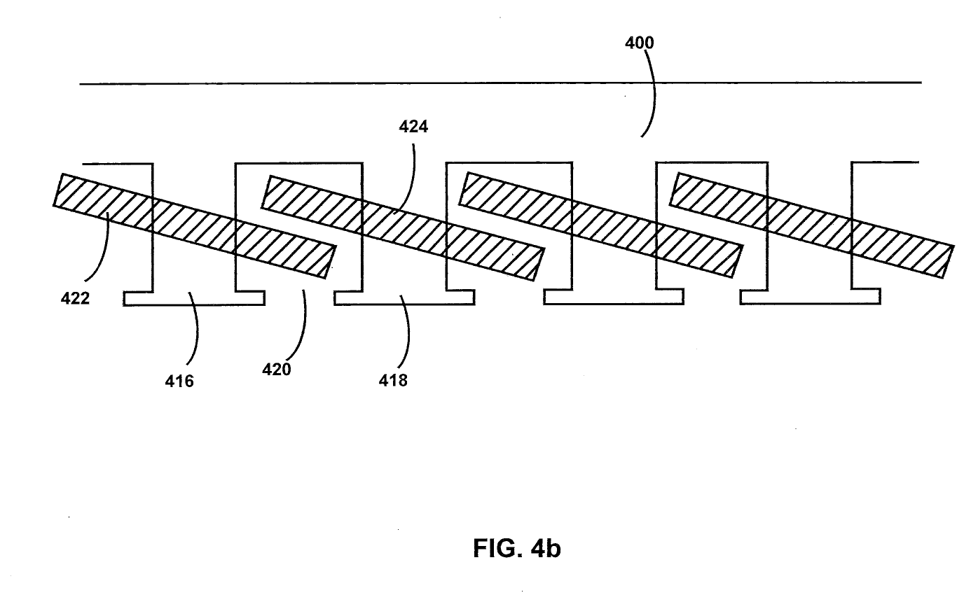

FIG. 4 illustrates a schematic illustration of a stator 400 of a motor with non-overlapping winding configuration in accordance with one or more implementations. The motor may comprise a five phase motor, having phases 406, 408, 410, 412, and 414. The stator 400 includes stator slots 402. Within the stator slots 402, there may be stator windings 404. The windings 404 may be configured so that the individual phase windings, 404, do not overlap with other phase windings, such that the individual phases 406, 408, 410, 412 and 414 do not overlap.

FIG. 4b illustrates a partial schematic view of a stator 400 with a non-overlapping winding configuration. Stator 400 may comprise stator teeth, such as stator teeth 416 and 418. Between stator teeth 416 and 418 may be a stator slot 420. Coils may be wound about the stator teeth, such that coil 422 may be wound about stator tooth 416 and coil 424 may be wound about stator tooth 418. Coils 416 and 418 may be adjacent coils but have no stator teeth around which both coils are wound. Therefore, in such configurations, the stator 400 has a non-overlapping winding configuration.

FIG. 5 illustrates a schematic cross-sectional view of a multiphase induction electric motor 500. The multiphase induction electric motor 500 may have a rotor 502 having a first set of rotor channels 504. Where the electric motor 500 is an induction motor, the first set of rotor channels 504 may comprise rotor slots. The first set of rotor channels 504 may be distributed on the outer surface of the rotor 502. The electric motor may have a winding positioned radially outward from the rotor 502. The rotor 502 may comprise a shaft cavity 506 configured to support the rotor 502 and transmit mechanical power from the motor 500 down a shaft (not shown). The rotor 502 may comprise a set of slotted laminations pressed together to form a cylindrical magnetic circuit. The rotor 502 may comprise a set of bars installed into the slots. The bars may be made from conductive metal. Such conductive metal may comprise aluminum or copper. The rotor bars may be short circuited on both sides by a conductive ring. Alternatively the rotor 502 may comprise rotor windings with connections brought out to slip rings mounted on one end of the shaft (not shown).

It has been found that for an induction motor, the slot-per-pole ratio may be between 0.6 and 2.5 for non-overlapping end-windings and a ratio of 1.2-5.0 for partially overlapping end windings.

The induction electric motor 500 may have a rotor 502 comprising of one or more conductors distributed radially about the surface of the rotor 502 in the first set of rotor channels 504. The number and shape of the rotor channels 504, or slots, may be selected to minimize the torque ripple and achieve a desired average torque for the electric motor 500. The one or more conductors may comprise solid conductors or stranded conductors. The solid conductors may have flat edges providing thermal contact with a lining of individual ones of the first set of rotor channels 504. The one or more solid conductors may have a shape selected to match the shape of the first set of rotor channels 504.

The electric motor 500 may comprise a stator 508 having stator slots 510 and stator teeth 512. Coils 514 may be wound around the stator teeth 512. The individual ones of the coils 514 may comprise end windings adjacent the ends of the stator 508. The coils 514 may be positioned such that the end windings of adjacent coils 514 at the ends of the stator 508 are non-overlapping (see FIGS. 4a and 4b) or partially overlapping (see FIGS. 3a and 3b) resulting from fractional slot per pole per phase winding.

The coils 514 may be formed using solid conductors or stranded conductors. Solid conductors may provide a higher fill factor for the coils 514 which may provide increased thermal contact with a lining of the stator slots 510. The coils 514 comprising one or more solid conductors may have flat edges providing thermal contact with a lining of individual ones of the first set of stator slots 510. The one or more solid conductors may have a shape selected to match the shape of the first set of stator slots.

Where the end windings of adjacent coils are non-overlapping (see FIGS. 4a and 4b), each coil returns from a neighboring slot so that only one coil 514 passes over an individual tooth 512 of the stator 508. In such configurations, the coil is said to span over one stator tooth 512. Where the end windings of the adjacent coils 514 are partially overlapping, each coil 514 returns from the slot 510 next to the neighboring slot 510 so that two coils 514 pass over an individual tooth 512 of the stator 508. In such configurations, the coil is said to span over two stator teeth.

The number of stator slots 510 affects the weight, cost and operating characteristics of a motor. Increasing the number of stator slots 510 decreases leakage resistance, decreases tooth pulsation losses and increases overload capacity.

Between the rotor 502 and stator 508, there is an air gap 516. Certain performance characteristics of the motor 500 are affected by the dimensions of the air gap 516. Performance parameters affected by the length of the air gap 516 include the magnetizing current, power factor, over load capacity, cooling and noise. A larger air gap 516 width increases overload capacity, increases cooling, reduces unbalanced magnetic pull, reducing in tooth pulsation and reduces noise. However, a larger air gap 516 increases the magnetizing current and reduces the power factor.

FIG. 6 illustrates a cross-sectional view of a stator slot 600 of an electric motor, in accordance with one or more implementations. The stator slot 600 may comprise a conductor 608. The conductor 608 may be a solid conductor, having increased fill factor, or may be a stranded conductor having a decreased fill factor, compared to the solid conductor. Coil insulation 610 may separate the conductor 608 from the stator tooth wall 612 and the coil separator 614. The stator slot 600 may comprise slot lining 616. The conductor 608 may further comprise conductor insulator 618. The stator slot 600 may comprise a wedge 620 configured to fix the conductor 608, coil insulation 610, coil separator 614, slot lining 616 and conductor insulator 618 in the stator slot 600. There may be a gap between the wedge 620 and the inside surface of the stator. The part of the stator slot 600 spanning this gap may be the stator lip 622. In other implementations, the stator may have closed slots, such that there is no space between the wedge 620 and the inner periphery of the stator 600.

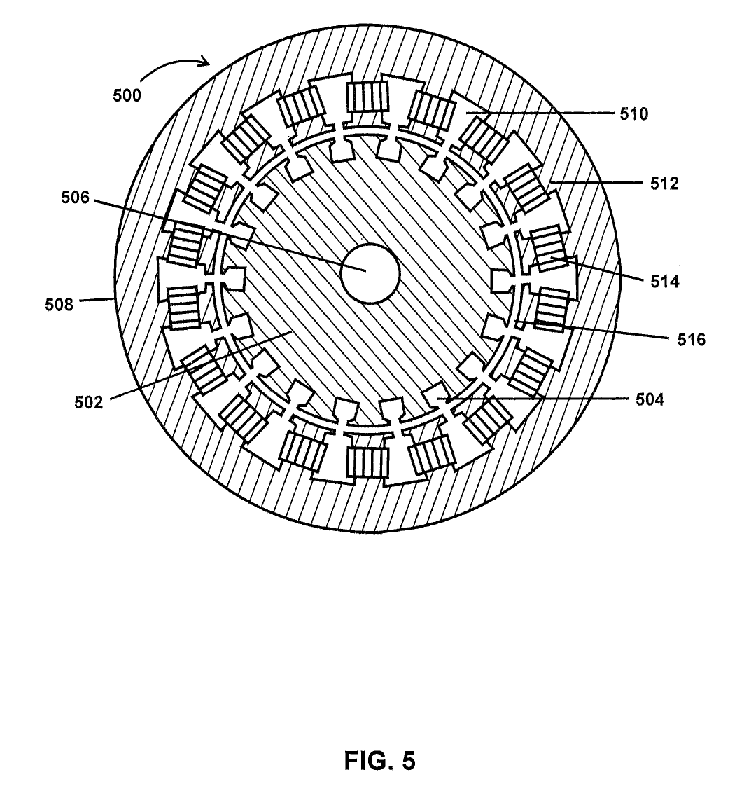

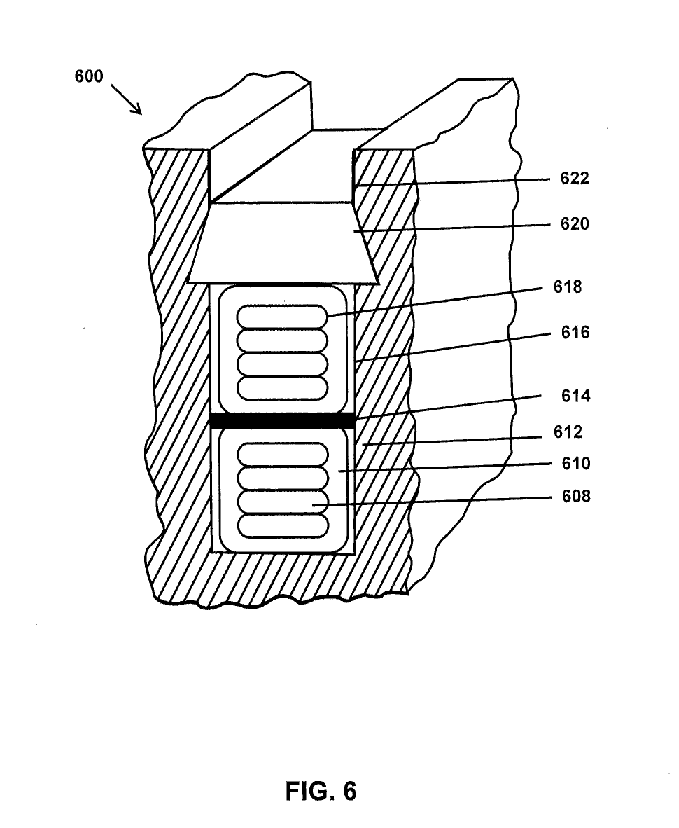

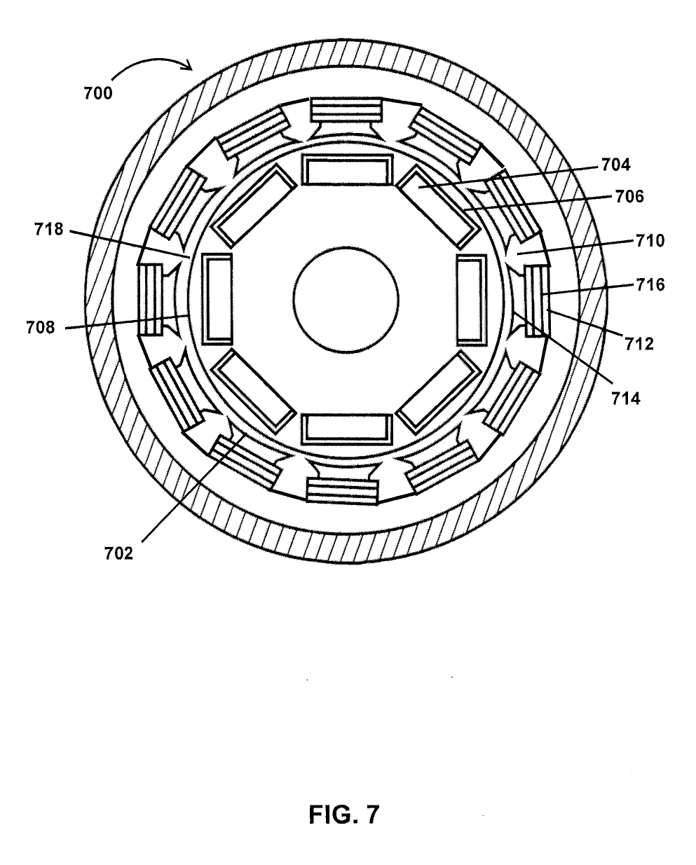

FIG. 7 illustrates a schematic cross-sectional view of a permanent magnet electric motor 700 in accordance with one or more implementations. The multiphase permanent magnet electric motor 700 may have a rotor 702 having a first set of rotor channels 704. Where the electric motor 700 is a permanent magnet motor, such as that illustrated in FIG. 7, the first set of rotor channels 704 may comprise rotor voids. In some implementations, the rotor 702 may have no voids. The first set of rotor voids 704 may be distributed around the circumference of the rotor 702. Such rotors may be referred to as surface mounted permanent magnet rotors.

The first set of channels 704 may be disposed internal of the rotor surface 708 and may be partially or completely filled with permanent magnets, as shown in FIG. 7. Such rotors may be referred to as permanent magnet assisted synchronous reluctance rotors. When an electric motor 700 comprises a rotor such as rotor 702, the motor may be referred to as a permanent magnet assisted synchronous reluctance machine (PMaSynRM).

The rotor 702 may consist of a soft magnetic material having voids 704. The voids 704 may be completely filled or partially filled with permanent magnets. The voids 704 may comprise a lining 706 between at least one side of the void 704 and the permanent magnet. The configuration of the void 704 and/or permanent magnet 706 may be selected to provide desired characteristics of the electric motor 700. The number and shape of the rotor voids 704 may be selected to minimize the torque ripple and achieve a desired average torque for the electric motor 700. The permanent magnets may have edges that complement the shape of the voids, so as to increase the thermal contact between the permanent magnets and the voids 704. The amount of permanent magnet disposed in the voids of the rotor may be chosen to provide an acceptable torque′ density as well as a high efficiency extended speed range.

It has been found that for permanent magnet motors with non-Overlapping end windings, the slot-per-pole ratio should be between 0.75 and 1.5, where an approximately 1-to-1 ratio has been found to provide peak performance. For permanent magnet motors with partially overlapping end windings, the slot-per-pole ratio should be between 1.5 and 3; where an approximately 2-to-1 ratio has been found to provide peak performance.

The permanent magnet electric motor 700 may comprise a stator having stator slots 710. Coils 716 may be wound around the stator teeth 714. The individual ones of the coils 714 may comprise end windings adjacent the ends of the stator 710. The coils 716 may be positioned such that the end windings of adjacent coils 716 at the ends of the stator 710 are non-overlapping (See FIGS. 4a and 4b) or partially overlapping (see FIGS. 3a and 3b) resulting from a fractional slot per pole per phase winding.

The coils 716 may be formed using solid conductors or stranded conductors. Solid conductors may provide a higher fill factor for the coils 716, which may provide increased thermal contact with a lining of the stator slots 710. The coils 716 comprising one or more solid conductors may have flat edges providing thermal contact with a lining of individual ones of the first set of stator slots 710. The one or more solid conductors may have a shape selected to match the shape of the first set of stator slots.

Solid conductors have an increased fill factor. The increased fill factor results in better magnetic utilization through the length of the motor. The losses and operating temperature of the motor can, therefore, be reduced while achieving the same torque. Conductors having a complementary shape to the void in which they are disposed, for example, having edges or surfaces mirroring the edges or surfaces of the voids, making better thermal contact with slot lining insulation, which helps in reducing peak spot temperatures. Peak spot temperatures are localized high-temperature regions on the conductor which cause localized failures of the conductor insulation. Using solid conductors which result in slot fill factors equal or in excess of the 65% of the slot area being conducted helps to reduce peak spot temperatures.

Small radius applications, such as down-hole electrical submersible pumps, rectangular slot, or void shapes result in stator teeth having a trapezoidal shape with a significant taper. It has been found that such tapers do not help to reduce losses, and, therefore, rectangular teeth can be used, resulting in trapezoidal slot, or void, shapes with significant taper. Where the stator voids have a trapezoidal shape with a significant taper, a matching conductor shape may be needed to achieve high slot fill factor. Conductors may be distributed in a manner so that loss distribution in them results in minimum peak spot temperatures. Conductors may be disposed into the stator voids axially and the connections may be made by soldering, welding, or joining the conductor ends as required.

Between the rotor 702 and stator 712 there is an air gap 718. Certain performance characteristics of the motor 700 are affected by the dimensions of the air gap 718, as discussed above with reference to the induction electric motor illustrated in FIG. 5.

In PMaSynRM systems the torque produced by the motor may be given by the following expression:

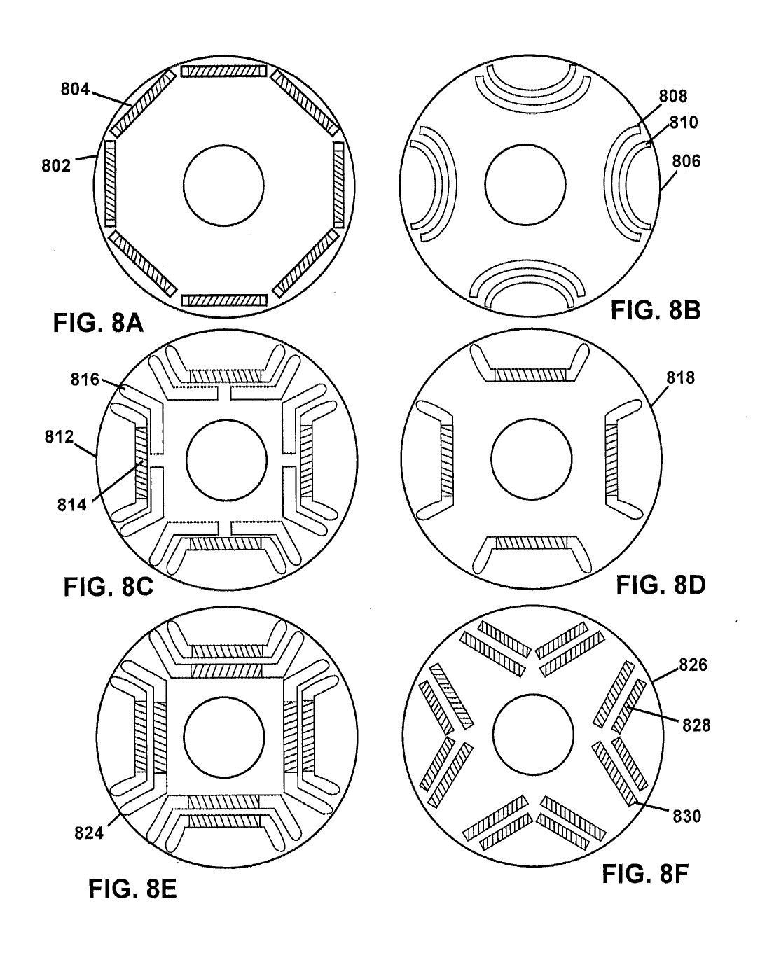

T=k[λ_{PM}i_{d}+(L_{d}−L_{q})i_{q}i_{d})

Where λ_{PM} is the permanent magnet flux linkage and L_{d} and L_{q} are the d and q axis inductances. The difference in inductance between the d and q axis, also defined as saliency, may be created by different types of voids in the rotor structure as shown in the rotors illustrated in FIGS. 8A to 8F. The torque created by the effect of saliency is the reluctance torque given by the second term in the toque equation. Permanent magnet torque represented in the first term of the torque equation may be created by partially or completely filling voids with permanent magnets. Partially or fully filling voids in the rotor with permanent magnets may improve torque density by varying the concentration of flux due to the different shapes of the permanent magnets By optimizing the shape of the voids (saliency) and the amount of permanent magnet in the rotor it may be possible to achieve higher efficiencies over a wider speed range as compared to other motor types.

FIGS. 8A to 8F illustrate permanent magnet rotors having different shaped voids and the amount of permanent magnets within the voids. The rotors illustrated in FIGS. 8A to 8F provide PMaSynRMs having different characteristics and properties. FIG. 8A illustrates a rotor 802 having lineal voids 804 filled or partially filled with permanent magnets. FIG. 8B illustrates a rotor 806 having curvilinear voids, where a larger curvilinear void 808 surrounds a small curvilinear void 810, with no permanent magnets. FIG. 8C illustrates a rotor 812 having voids 814 partially filled with permanent magnets and voids 816 not unfilled with permanent magnets. FIG. 8D illustrates a rotor 818 having a similar configuration to the rotor of FIG. 8C, but without having the empty voids. FIG. 8E illustrates a rotor 824 similar to that of FIG. 8C but where all voids are partially filled with permanent magnets. FIG. 8F illustrates a rotor 826 where the v-shaped voids 828, 830 are not tangential to the surface of the rotor 826. The rotor designs of FIGS. 8A-8F are not intended to be limiting, but are merely provided as illustrations of the many different permanent magnet rotor configurations available for the permanent magnet motor system.

Modifying the phase angle advancement allows the electric motor to be operated at lower voltages over an extended speed range as compared to other motor designs. This will allow wide range of operating points when load characteristic changes due to well conditions, such as temperature, specific gravity and the viscosity of oil and depth changing over time. By having an extended speed range over which the motor is operating at its peak efficiency operating point, the copper loss, or heat generation, of the motor is maintained at a more constant level and, therefore, it does not compromise the reliability of the winding insulation.

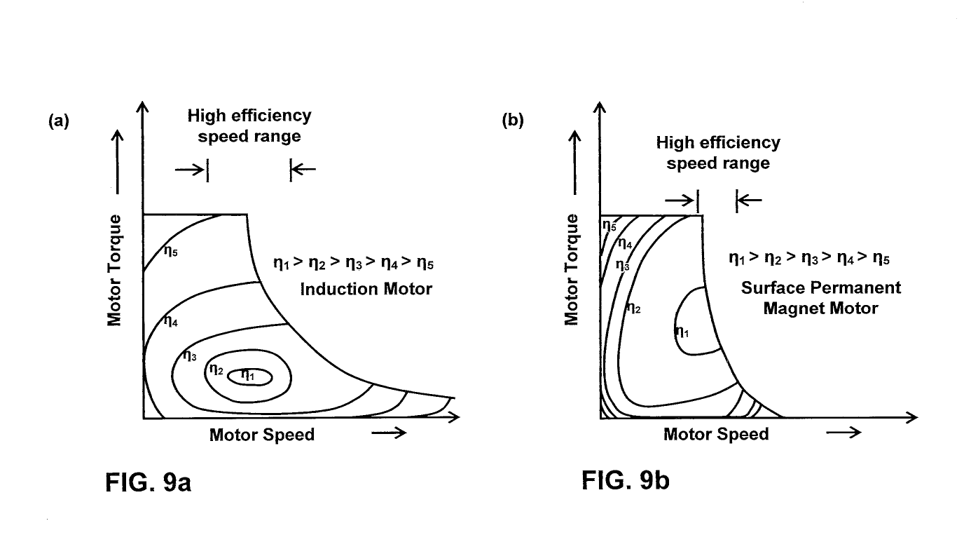

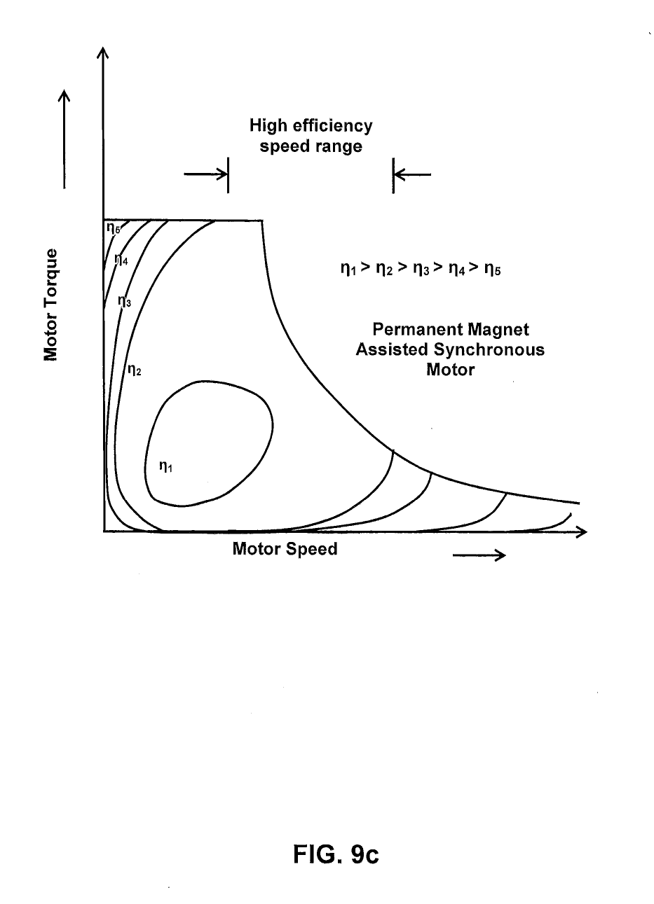

FIGS. 9a-9c illustrate the torque speed curve and efficiency map of electric motors having different configurations. FIG. 9a illustrates the torque speed curve and efficiency map for a conventional induction motor. FIG. 9b illustrates the torque speed curve and efficiency map for a surface permanent magnet motor, where the rotor of the motor consists of voids in the rotor outer surface filled, or partially filled, with permanent magnets. FIG. 9c illustrates the torque speed curve and efficiency map for a permanent magnet assisting the synchronous reluctance machine (PMaSynRM). Observed is the high efficiency operating region of the PMaSynRM compared to that of the induction motor of FIG. 9a and the surface permanent magnet motor of FIG. 9b. The PMaSynRm motor type has a wider speed range and high efficiency operating region as compared to other motor types.

By providing a multiphase (more than three) electric motors having no or partial overlap between phases, the motor may continue to be operational even after one or more of the phases are in fault.

A DC voltage for monitoring the phases may be applied using an inverter by the controller 204 (as shown in FIG. 2). The monitoring system may include current sensors on each phase of the inverter output to measure the current for controlling the motor and for monitoring the phases (DC component). The DC voltage may be additionally monitored using voltage sensors (not shown) also located on each phase in the inverter output. The DC voltage may be supplied by the inverter. The controller may be configured to use the sensor outputs to detect a decrease in resistance in individual ones the phases in the first set of phases, indicating that one or more of the individual ones of phases may have a short. Once a short is detected in one or more of the phases of the first set of phases, the controller (as shown in FIG. 2) may be configured to open the one or more faulty phases, such that AC current is no longer passed through the faulty phases.

In some implementations, the controller 204 (as shown in FIG. 2) may be configured to inject a relatively small DC voltage through the inverter into one or more of the phases of the electric motor. The monitoring device 206 may be configured to measure the current due to the injected DC voltage and the DC voltage to obtain an estimation of the DC resistance of the individual phase windings of the electric motor.

The DC resistance of individual ones of the phase windings may be compared with each other and compared with previous measurements to obtain a measure of change of the DC resistance of individual ones of the phase windings. The measurement of the DC resistance may be discrete, wherein the DC voltage may be applied by the controller 204 to the phases of the electric motor at predetermined and/or selected intervals, and/or as desired, to obtain the DC resistance measurements. A faulty phase winding may be determined based on the DC resistance measurements for the phase indicating that the phase has a short circuit.

The temperature of the phase windings may affect the resistance of the phase windings and, therefore, if not accounted for, may give a false measurement that a phase is in fault. Temperature typically affects the phase windings uniformly and, therefore, by comparing the changes in resistance of each of the individual phases the effect of temperature can be accounted for. During manufacture of the phase windings, the phase windings may not be electrically balanced properly, and therefore unbalances in the phase windings created during manufacture may also be accounted for.

In order to implement space vector modulation a reference signal is generated from n separate phase references (where n is the number of phases in operation) using the αβγ transformation.

In response to detection of the shorted phase by the monitoring device 206, the controller 204 may be configured to adjust control of the transmission of power, from the power source 208, to the multiphase electric motor 202 such that power is transmitted to a second set of phases in accordance with a second operating configuration. In response to the detection of a shorted phase in the original set of phases, power from the power source may be provided to a different set of phases where the second set of phases 322 does not include the shorted phase, although it may include all of some of the phases in the original set of phases.

The multi-phase electric motor 202 (as shown in FIG. 2) may be configured to drive a down hole electrical submersible pump (ESP). Providing a motor capable of operating when one or more of the phase windings have a fault increases the operational life of the motor between maintenance sessions. Decreasing downtime, especially when used in ESP applications, reduces the cost of work overs, reduces costs in various operational areas and brings a significant enhancement to well profitability.

The monitoring device 206 (as shown in FIG. 2) may be configured to monitor the transmission of power to the first set of phases of the multiphase electric motor. The monitoring device 206 may be further configured to monitor one or more of the positive sequence, negative sequence, and/or zero sequence current and/or voltage of the power transmitted from the power source 208 to the first set of phases of the multiphase electric motor 202, and/or the resistance of individual ones of the first set of phases of the multiphase electric motor 202.

The controller 204 may be configured to determine parameters for the transmission of power to the multiphase electric motor 202, such that the power is transmitted to a second set of phases in accordance with the second operating configuration. The second operating configuration may be such that the system 200 is adapted to determine parameters for the transmission of power to the second set of phases of electric motor 202, such that the electric motor 202 is operated within one or more defined thresholds of the first operating configuration.

The current magnitude for the power transmitted to individual ones of the second set of phases may be determined such that a total copper loss for the electric motor being operated in the second operating configuration is within a defined threshold of the total copper loss for the electric motor being operated in the first operating configuration. The phase for the current of the power transmitted to individual ones of the second set of phases may be determined such that the harmonic torque ripple of the second set of phases of the electric motor being operated in the second operating configuration is within a defined threshold of a harmonic torque ripple for the power transmitted to the electric motor being operated in the first operating configuration and the total zero sequence current is zero. The controller 204 may be further configured to transmit power having a current with a determined current magnitude and a determined phase shift to individual ones of the second set of phases.

When a phase of a multi-phase electric motor (such as electric motor 202 in FIG. 2) are opened due to a fault, it is possible to continue to generate a rotating magnetic field using the remaining phases. For example, with a five-phase electric motor it is possible to have one phase, or even two phases, opened due to faults and continue to generate a rotating magnetic field using the remaining four, or three, phases. However, applying current with the same current magnitudes and phase shifts to the second set of phases, as applied to the first, will result in a high torque pulsation due to the loss of one or more phases. As previously stated, the current magnitudes to be applied to the second set of phases in the second configuration are chosen to keep the total copper loss within a determined threshold of when the electric motor is operating in the first configuration with the first set of phases. Operating the electric motor in such a manner maintains the operating temperature of the motor within a defined threshold, minimizing the need for additional cooling while operating the electric motor in the second configuration.

The phase shift of the current applied to the second set of phases may be determined to satisfy various constraints. Firstly, the phase shift of the current applied to the second set of phases is determined such that the total instantaneous current applied to all phases in the second set of phases is within a determined threshold of zero. This reduces the zero sequence current, the presence of which may lead to bearing failure and losses, necessitating early replacement of the electric motor.

Secondly, the phase shift of the current applied to the second set of phases is determined such that the second harmonic torque ripple is within a determine threshold of zero. A more accurate compensation of torque ripple in permanent magnet motors may be provided by cancelling, or approximately cancelling, the flux harmonics that create the second harmonic torque ripple. To cancel, or approximately cancel, the flux harmonics that create the second harmonic torque ripple an analytical field solution of the air gap flux density due to the permanent magnets may be used. The instantaneous torque may be derived using the instantaneous gap flux density and the current sheet distribution:

$${T}_{a} ( θ ) = \frac{2 π {r}^{2} l}{N} {\sum }_{i = 1}^{N} {B}_{PM} ( \frac{2 π}{N} i + θ ) {K}_{a} ( \frac{2 π}{N} i )$$

Where B_{PM} is the air gap flux density function, N is the number of samples, r is the air gap radius, l is the stack length and Kₐ is the surface current density of a phase given by:

$$K ( \frac{2 π}{N} i ) = \pm \frac{{I}_{M}}{{w}_{s}}$$

if

$$\frac{2 π}{N} i$$

is in a slot of “A” phase and 0 elsewhere.

The total torque is the sum of the torques due to all the phases:

$$T ( t ) = {\sum }_{j = 1}^{{N}_{p h}} {\sum }_{k = 1}^{N} {T}_{k} sin ( ω t - ( j - 1 ) \frac{2 π}{{N}_{p h}} ) {i}_{j} ( t )$$

Where Tₖ is the peak of the k^{th} component of the per phase torque and Nₚₕ is the total number of phases.

In the absence of “A” phase, iₐ=0. By proper choice of phase angles of i_{b}, i_{c}, i_{d}, iₑ, the second harmonic torque component can be cancelled. The amplitude and phase of the current to be injected to cancel the second harmonic torque is thus dependent on the configuration of the winding and the number of slots.

For induction motors compensation of torque ripple may be provided by including the effect of the third harmonic magneto-motive force (MMF) produced by the modular stator winding. By injecting third harmonic currents into the stator phase windings, it is possible to eliminate, or approximately eliminate, the second harmonic torque when operating under fault conditions. The total MMF is given by:

$$MMF ( ϕ , t ) = {\sum }_{j = 1}^{{N}_{p h}} ( {N}_{t 1} cos ( ϕ - ( j - 1 ) \frac{2 π}{{N}_{p h}} ) {i}_{j 1} ( t ) + {N}_{t 3} cos ( 3 ϕ - 3 ( j - 1 ) \frac{2 π}{{N}_{p h}} ) {i}_{j 3} ( t ) )$$

Where Nₜ₁ and Nₜ₂ are the fundamental and third harmonic components of the stator winding function and i_{jf}(t) and iⱼ₃(t) are the fundamental and third harmonic currents. The total MMF under healthy conditions, i.e., when there are no opened phases for a five phase motor that contributes to a net average torque and zero ripple torque is given by:

$$MMF ( ϕ , t ) = \frac{5}{4} ( {N}_{t 1} {I}_{m 1} cos ( ω t - ϕ ) + {N}_{t 3} {I}_{m 3} cos ( 3 ω t - 3 ϕ ) )$$

In the case of a five-phase electric motor, the above two expressions can be equated under single and two phase faults to obtain the amplitude and phase angle of the healthy phases to reduce ripple torque.

Injection of higher order harmonic currents can help eliminate, or approximately eliminate, higher order torque pulsations that are created during faults.

The system 200, shown in FIG. 2, may comprise one or more elements configured to carry out the functions of one or more of the electric motor 202, controller 204, monitoring device 206 and power source 208, inverter and/or other elements. The elements 202, 204, 206, 208 and/or other elements may be individual or combined. The elements 202, 204, 206, 208 and/or other elements may be co-located or located in separate locations. For example, elements 204, 206, 210, and/or other elements may be integrated with the electric motor 202. In other implementations, the elements 204, 206, 210 and/or other elements may be separate from the electric motor 202 and positioned elsewhere.

The monitoring device 206 and/or controller 204 may include electronic storage, one or more processors, and/or other components. The monitoring device 206 and/or controller 204 may include communication lines, or ports to enable the exchange of information with a network, each other and/or the electric motor 202. Illustration of system 200, and elements 202, 204, 206, 208 and/or other elements in FIG. 1 is not intended to be limiting. The system 200, and elements 202, 204, 206, 208 and/or other elements may include a plurality of hardware, software, and/or firmware components operating together to provide the functionality attributed herein to system 200.

Processor(s) may be configured to provide information processing capabilities in system 200, such as with the monitoring device 206 and/or controller 204. As such, the processor may include one or more of a digital processor, an analog processor, a digital circuit designed to process information, an analog circuit designed to process information, a state machine, and/or other mechanisms for electronically processing information. The processor(s) may be configured to execute computer software and/or hardware components to operate the system 200.

Although the present technology has been described in detail for the purpose of illustration based on what is currently considered to be the most practical and preferred implementations, it is to be understood that such detail is solely for that purpose and that the technology is not limited to the disclosed implementations, but on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A multiphase electric motor for a down-hole electrical submersible pump comprising:
an electric motor having:
a rotor having a first set of rotor slots;
a stator having three or more stator slots, three or more stator teeth and three or more coils, wherein individual ones of the three or more coils are wound about at least one of the individual ones of the three or more stator teeth, forming a fractional slot per pole per phase winding;
a power supply configured to provide power to the three or more phase windings formed by the three or more coils; and
a controller configured to control transmission of power through the three or more windings.

2. The multiphase electric motor as in claim 1, wherein the coils comprise end windings adjacent the end of the stator, and are configured such that the end windings span one stator tooth to form a fractional slot per pole per phase winding.

3. The multiphase electric motor as in claim 1, wherein the coils comprise end windings adjacent the end of the stator, and are configured such that the end windings span at least two stator teeth to form a fractional slot per pole per phase winding.

4. The multiphase electric motor as in claim 1, wherein the rotor further comprises one or more solid bars distributed radially about the surface of the rotor in the first set of rotor slots.

5. The multiphase electric motor as in claim 4, wherein the one or more solid conductors have flat edges providing thermal contact with a lining of individual ones of the first set of rotor slots, and wherein the one or more solid conductors has a shape selected to match the shape of the first set of rotor slots.

6. The multiphase electric motor as in claim 1, wherein the stator further comprises one or more solid bars distributed radially about the inside surface of the stator in the first set of stator slots.

7. The multiphase electric motor as in claim 6, wherein the one or more solid conductors have flat edges providing thermal contact with a lining of individual ones of the first set of stator slots, and wherein the one or more solid conductors has a shape selected to match the shape of the first set of stator slots.

8. The multiphase electric motor as in claim 1, wherein the controller is configured to modify the phase angle between a voltage induced in the coils by the power source and the current applied to the coils by the power source.

9. A multiphase electric motor for a down-hole electrical submersible pump comprising:
an electric motor having:
a rotor;
a stator having three or more stator slots, three or more stator teeth and three or more coils, wherein individual ones of the three or more coils are wound about at least one of the individual ones of the three or more stator teeth, and positioned such that adjacent coils form a fractional slot per pole per phase winding;
a power supply configured to provide power to the three or more phase windings formed by the three or more coils; and,
a controller configured to control transmission of power through the three or more windings.

10. The multiphase electric motor as in claim 9, wherein the coils comprise end windings adjacent the end of the stator, and are configured such that the end windings of adjacent coils span one stator tooth to form a fractional slot per pole per phase winding.

11. The multiphase electric motor as in claim 9, wherein the coils comprise end windings adjacent the end of the stator, and are configured such that the end windings of adjacent coils span at least two stator teeth to form a fractional slot per pole per phase winding.

12. The multiphase electric motor as in claim 9, further comprising a selected amount of permanent magnet material distributed on the outer periphery of the rotor.

13. The multiphase electric motor as in claim 9, further comprising a first set of rotor voids distributed internally of the outer surface of the rotor.

14. The multiphase electric motor as in claim 13, wherein the rotor voids include a selected amount of permanent magnet material positioned in individual ones of the first set of rotor voids.

15. The multiphase electric motor as in claim 12, wherein the amount of permanent magnet positioned at individual locations on the outer periphery of the rotor is determined to provide a desired torque density and efficiency of the electric motor.

16. The multiphase electric motor as in claim 12, wherein the permanent magnet material distributed on the outer periphery of the rotor has one or more shapes configured to provide a desired torque density and efficiency of the electric motor.

17. The multiphase electric motor as in claim 12, wherein the permanent magnet material is a samarium-cobalt magnetic material.

18. The multiphase electric motor as in claim 9, wherein the stator further comprises one or more solid bars distributed radially about the inside surface of the stator in the first set of stator slots.

19. The multiphase electric motor as in claim 18, wherein the one or more solid conductors have flat edges providing thermal contact with a lining of individual ones of the first set of stator slots, and wherein the one or more solid conductors has a shape selected to match the shape of the first set of stator slots.

20. The multiphase electric motor as in claim 9, wherein the controller is configured to modify the phase angle between a voltage induced in the coils by the power source and the current applied to the coils by the power source.
